(19) United States
(12) Patent Application Publication
(10) Pub. No.: US 2003/0031786 A1
(43) Pub. Date: Feb. 13, 2003

(54) Process to coat granular and powdered materials

(75) Inventors: Karlheinz Rumpler, Weimar (DE); Michael Jacob, Weimar (DE); Mike Waskow, Jena (DE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Glatt Ingenieurtechnik GmbH, Weimer (DE)

(21) Appl. No.: 10/183,912

(22) Filed: Jun. 26, 2002

(30) Foreign Application Priority Data
Jun. 26, 2001 (DE) 101 30 334.3

(51) Int. Cl. B05D 7/00; B05D 1/12

(52) U.S. Cl. 427/212; 427/213; 427/180

(57) ABSTRACT

A process to coat granular through powdered material for particular bulk products that is cost-effective for bulk products and in which the coated product is produced continuously and in a quality and throughput that meets requirements for bulk products is provided. This is attained by the coating material being applied to the granular through powdered material particles in the form of a coating matrix that does not completely envelope the material particles with coating material, with the matrix then being dried and solidified by the process air, the coating material is applied continuously to the bed of material in a continuously operated fluidized bed in at least two different zones. The coating material is applied to the material particles located in the fluidized bed in the form of solutions, suspensions or melts with a solids fraction of 0.5 to 100%, preferably 2 to 20%. The coating materials are preferably inorganic salts, fats, waxes, celluloses, stearates, metals or metal compounds, and the temperature of the air fed to the fluidized bed for the coating area is dependent on the material, and is between −20° C. to +300° C. The end product is continuously discharged from the fluidized bed.

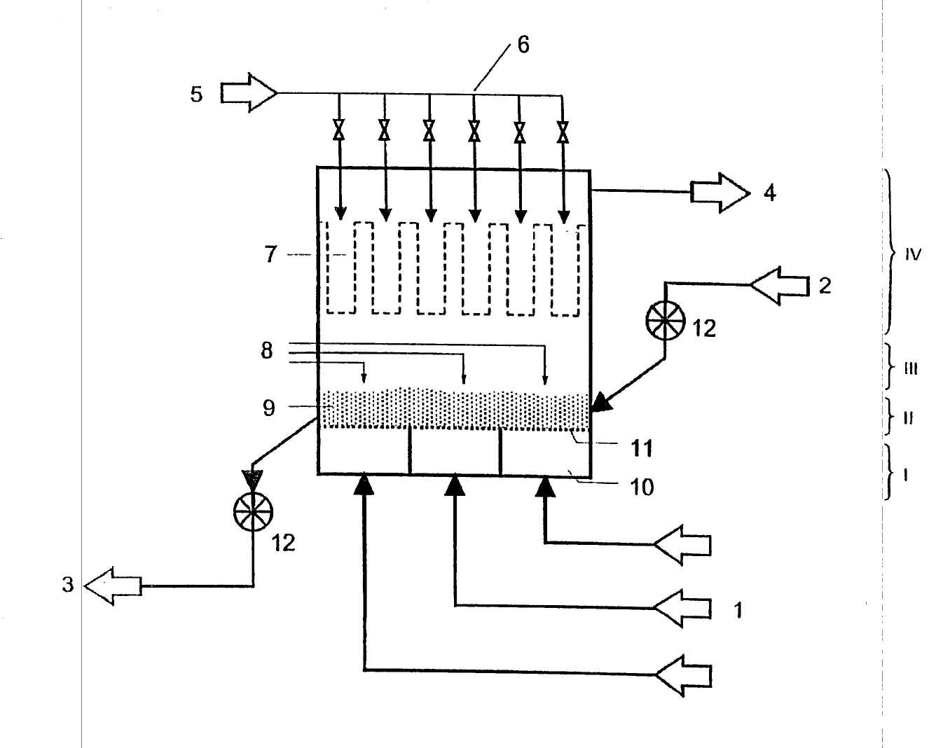

### BACKGROUND

This invention pertains to a process to coat granular to powdered materials, in particular bulk products that have a coating material applied.

A process is known to influence the properties of granular to powdered materials by enclosing them with a protective layer. The purpose of these protective layers is to increase the stability of the treated materials in storage, prevent the materials from undergoing chemical change or to mask properties such as smell, taste and tackiness, and to influence the materials' wettability. This protective layer also makes it possible to significantly reduce the wear rate of the material. When applying the protective layer, care must be taken that the components contained in the enclosed material are released within a specific time frame in a controlled manner dependent upon the application. By using enzymes, catalysts, substances that activate in the wash, metals and metal compounds, a functional surface of the product particles is attained.

In the pharmaceutical industry, there is a known coating for granular through powdered materials. One condition in processes used in the pharmaceutical industry is that each material particle must be exposed for the same amount of time, and thus to the same conditions, during the coating process. All material particles are provided with the same coating parts and closed coating layers are applied to the particles. In order to meet these high quality features, the coating of pharmaceutical products is done in batch processes in a fluidized bed or in a rotating drum. In this processing, only small amounts of the material to be treated can be added to the fluidized bed or the rotating drum in order to attain these quality features.

The disadvantage to these processes is that they are only suitable for small product amounts due to the batch nature of the operation, and that they attain coating qualities that are not necessary in bulk products and are not justifiable on a cost basis.

### SUMMARY

The object of this invention is to develop a process to coat granular through powdered materials that can be made to be cost effective for bulk products and in which the coated product is produced continuously and in a quality and throughput that meets requirements for bulk products.

This object is met by the features of the invention.

The coating of granular through powdered bulk products is done in a continuously operated fluidized bed in which the coating material is continuously applied to the bed of material located in the fluidized bed and in at least two different areas. The coating material is applied in the form of solutions, suspensions or melts with a solids fraction of preferably 2 to 20% and in the form of a coating matrix that does not completely envelope the material particles with coating material. This makes it possible to provide bulk products economically with a sufficient shell of coating material. The material particles provided with a coating matrix exhibit a functioning surface and thus meet the requirements demanded by their purpose at hand, such as to raise their stability in storage, to prevent changes in the chemical properties of the enclosed materials or to make it possible to influence the wettability of the treated materials. By using inorganic salts, fats, waxes, celluloses, stearates, metals or metal compounds as the coating material, a variety of bulk products having different purposes can be provided with an appropriate coating.

### BRIEF DESCRIPTION OF THE DRAWINGS

This invention is explained in more detail with the aid of the disclosed preferred embodiments. Schematically shown in the accompanying drawing is a cross section through a fluidized bed system to coat granular through powdered materials.

### DETAILED DESCRIPTION OF THE PREFERRED EMBODIMENTS

The process to coat various types of granular through powdered bulk products is carried out in a continuous fluidized bed system. The initial material, having a grain size less than 1 mm (and down to a powered material) is fed to a first area in the fluidizing zone 11 of the fluidized bed 9 by means of the solid feed inlet 2 and through a cellular wheel valve 12. Depending on the specific material requirements of the bulk products to be coated, the material passes through different areas of the fluidized bed 9. Different processes such as heating, agglomeration, coating, drying and cooling are carried out in a combination that is determined according to the respective material's properties. Compressed air 1 is fed to each area of the fluidized bed 9 through its respective air feed chamber 10 and through an air distribution plate 11. In this way, the air feed chambers 10 and the air distribution plate 11 form the air inlet section I, the distribution plate being its upper boundary. In this air inlet section I, the process air 1 is introduced to the fluidizing zone II, distributed and equalized. The coating material is continuously applied to the material to be coated, which is located in the fluidized bed 9, in the statistical center of at least two different areas by means of a spray system 8. The coating material is applied in the form of solutions, suspensions or melts with a solids fraction of 0.5 to 100%, and preferably 2 to 20%, to the material particles by the spray system 8. The injection of the coating material by the spray system 8 can be done from above onto the bed of material or from below into the bed of material, or using single or multi-material nozzles arranged at an angle. Depending on the materials to be processed and the properties of the end products to be attained, inorganic salts, fats, waxes, celluloses, stearates, metals or metal compounds are used as the coating material. The temperature of the air fed to the fluidized bed 9 (process air 1) is dependent on the material and is between −20° C., and in the case of melts, +300° C. for the individual coating stages. The energy input by the process air 1 causes the coating layers that form on the material particles located in the spray area to dry and solidify. Thereby, the coating material forms a coating matrix on the material particles wherein the material particles are not completely enveloped with coating material.

Above the fluidizing zone II is the expansion zone III in which the flow velocity of the process air 1 is reduced by expanding the cross sectional area of the system. The sidewalls of the expansion zone III have an angle of 15-45° to perpendicular so that the cross section expands until it reaches the filter system IV. By reducing the flow velocity of the process air 1, material particles that are entrained from the fluidizing zone II drop out of the flow stream and are returned to the fluidizing zone.

Next to the expansion zone III is an integrated filter system IV to remove dust from the process air 1 and at the same time to return the dust to the fluidized bed 9 below it. The filter system IV includes filter elements 7 that can be mechanically cleaned using a filter cleaning system 6 and/or using impulses of compressed air 5. The use of other known filter elements is possible as well. By integrating this filter system IV into the process, contact with the dust is prevented and the danger of dust explosion in the interior of the fluidized bed apparatus is reduced.

The cleaned process air leaves the system as exhaust 4, whereas the final product also is carried away from the system through an other cellular wheel valve 12, which acts as a pressure seal, and out through the product discharge 3.

Other equipment parts, for example for explosion suppression/relief or to support the motion of the solids, for example, can also be added to the system.

Below, the process according to the invention is explained with the help of the following examples.

### EXAMPLE 1

A detergent component, sodium percarbonate, with a grain size less than 1 mm is coated in a fluidized bed with four chambers at the air inlet and with a fluidizing base surface area of 0.2 m². In the process, a total of 5% coating material (dry material) is applied, in one chamber sodium sulfate, potassium silicate and an organic component, and in another chamber a mixture of sodium sulfate and sodium carbonate is applied.

The mass throughput of finished product is 100 kg/h.

| | |
|---|---|
| 1^{st} Chamber | Coating 1 |
| | Feed air temperature 190° C. |
| | Bed temperature 60° C. |
| | Spray medium 15% coating solution |
| | Coating amount 0.6% based on the dry material |
| 2^{nd} Chamber | Coating 2 |
| | Feed air temperature 190° C. |
| | Bed temperature 60° C. |
| | Spray medium 20% coating solution |
| 3^{rd} Chamber | Coating 3 |
| | Feed air temperature 190° C. |
| | Bed temperature 60° C. |
| | Spray medium 20% coating solution |
| | Coating amount 4.4% based on the dry material |
| | von coating 2 and 3 |
| 4^{th} Chamber | Drying |
| | Feed air temperature 75° C. |

Distribution of Fluidizing Area:

25% Coating 1

25% Coating 2

25% Coating 3

25% Drying

### EXAMPLE 2

Sodium percarbonate with a grain size less than 1 mm is coated in a fluidized bed with four chambers at the air inlet and with a fluidizing base surface area of 0.2 m². In this process, a total of 10% coating material (dry material) consisting of sodium sulfate is applied.

The mass throughput of finished product is 30 kg/h.

| | |
|---|---|
| 1^{st} Chamber | Coating 1 |
| | Feed air temperature 125° C. |
| | Bed temperature 60° C. |
| | Spray medium 15% coating solution |
| 2^{nd} Chamber | Coating 2 |
| | Feed air temperature 125° C. |
| | Bed temperature 60° C. |
| | Spray medium 15% coating solution |
| 3^{rd} Chamber | Coating 3 |
| | Feed air temperature 125° C. |
| | Bed temperature 60° C. |
| | Spray medium 15% coating solution |
| 4^{th} Chamber | Drying |
| | Feed air temperature 50° C. |

Distribution of Fluidizing Area:

25% Coating 1

25% Coating 2

25% Coating 3

25% Drying

### EXAMPLE 3

Betaine with a grain size less than 1 mm is coated in a fluidized bed with four chambers at the air inlet and with a fluidizing base surface area of 0.2 mm². In this process, a total of 10% coating material in the form of melted fat is applied.

The mass throughput of finished product is 30 kg/h.

| | |
|---|---|
| 1^{st} Chamber | Heating |
| | Feed air temperature 60° C. |
| | Bed temperature 52° C. |
| 2^{nd} Chamber | Coating 1 |
| | Feed air temperature 60° C. |
| | Bed temperature 52° C. |
| | Spray medium melted fat |
| 3^{rd} Chamber | Coating 2 |
| | Feed air temperature 60° C. |
| | Bed temperature 52° C. |
| | Spray medium melted fat |
| 4^{th} Chamber | Final treatment |
| | Feed air temperature 30° C. |

Distribution of Fluidizing Area:

25% Heating

25% Coating 1

25% Coating 2

25% Final treatment

### EXAMPLE 4

Powdered baby food is coated with lecithin to influence its wettability. In this manner, the re-dispersability of an instant product is significantly improved. The powdered material is first agglomerated in a fluidized bed with four chambers at the airflow inlet and a fluidizing surface area of 0.2 m² and then coated. The agglomeration is done with water, the coating is done with 15% Lecithin (dry material).

The mass throughput of finished product was 15 kg/h.

| | |
|---|---|
| 1^{st} Chamber | Agglomeration with water |
| | Feed air temperature 60° C. |
| | Bed temperature 35° C. |
| 2^{nd} Chamber | Agglomeration with water |
| | Feed air temperature 60° C. |
| | Bed temperature 35° C. |
| 3^{rd} Chamber | Coating 1 |
| | Feed air temperature 75° C. |
| | Bed temperature 42° C. |
| | Spray medium 50% Lecithin solution |
| 4^{th} Chamber | Coating 2 |
| | Feed air temperature 75° C. |
| | Bed temperature 42° C. |
| | Spray medium 50% Lecithin solution |

Distribution of Fluidizing Area:

25% Agglomeration

25% Agglomeration

25% Coating 1

25% Coating 2

In summary, the following has been determined:

This invention provides to a process to coat granular through powdered material, in particular bulk products.

The object of this invention is to provide a process to coat granular through powdered materials that can be made to be cost-effective for bulk products and in which the coated product is produced continuously and in a quality and throughput that meets requirements for bulk products.

According to the invention, this is attained in that

the coating material is applied to the granular to powdered material particles in the form of a coating matrix that does not completely envelope the material particles with coating material, said matrix then being dried and solidified by the process air,

the coating material is applied continuously to the bed of material in a continuously operated fluidized bed in at least two different zones,

the coating material is applied to the material particles located in the fluidized bed in the form of solutions, suspensions or melts with a solids fraction of 0.5 to 100%, preferably 2 to 20%,

the coating materials are inorganic salts, fats, waxes, celluloses, stearates, metals or metal compounds,

the temperature of the air fed to the fluidized bed for the coating area is dependent on the material, and is between −20° C. to +300° C.,

the end product is continuously discharged from the fluidized bed.

1. A process to coat granular through powdered material particles provided as bulk products, that have a coating material applied to the material particles, comprising:
applying a coating material to the granular through powdered material particles in a form of a coating matrix that does not completely envelope the material particles with the coating material, and then drying and solidifying the coating matrix with process air,
wherein the coating material is applied continuously to a bed of material in a continuously operated fluidized bed in at least two different zones,
the coating material being applied to the material particles located in the fluidized bed as solutions, suspensions or melts with a solids fraction of 0.5 to 100%,
the coating materials being inorganic salts, fats, waxes, celluloses, stearates, metals or metal compounds,
maintaining the temperature of air fed to the fluidized bed for the coating area dependent on the material between −20° C. to +300° C., and
continuously discharging end product from the fluidized bed.

2. A process according to claim 1, wherein
a coating material is added to sodium percarbonate, having a grain size less than 1 mm, located in the fluidized bed at three different areas in the fluidized bed,
a 10-20% coating solution including sodium sulfate, potassium silicate and an organic component is added to the fluidized bed, the amount of coating material being 0.3-1% based on the dry material,
a 15-25% coating solution including sodium sulfate and sodium carbonate with a coating material amount of 4-5% based on the dry material is added to the fluidized bed in a second and third area,
the material bed temperature in the three areas where the coating material is added is 40-80° C.,
the temperature of the incoming feed air in the area where the coating material is added is 160-220° C.,
the coated sodium carbonate is subsequently dried in another area of the fluidized bed at feed air temperatures of 60-80° C.

3. A process according to claim 1, wherein
a coating material in the form of a 10-20% coating solution including sodium sulfate is added to sodium percarbonate, having a grain size less than 1 mm, located in the fluidized bed at three different areas in the fluidized bed, the coating material amount being 5-15% based on the dry material,
the material bed temperature in the three areas where the coating material is added is 40-80° C., the temperature of the incoming feed air in the area where the coating material is added is 100-150° C., and
the coated sodium percarbonate is subsequently dried in another area of the fluidized bed at a feed air temperatures of 40-60° C.

4. A process according to claim 1, wherein
to coat Betaine with a grain size less than 1 mm in a first area of the fluidized bed, the material is heated to 45-55° C., preferably 52° C., at feed air temperatures of 50-70° C.,
a total of 5-15% of melted fat a coating material is added to the material in a second and third area at a bed temperature of 45-55° C.,
the material bed temperature in the area where the coating material is added is 45-55° C.,
the temperature of the incoming feed air in the area where the coating material is added is 50-70° C., and
in a fourth area of the fluidized bed, a final treatment of the coated material is done at feed air temperatures of 20-40° C.

5. A process according to claim 1, wherein
powdered baby food is agglomerated with water, in a first and second area of the fluidized bed,
the material bed temperature in the area of agglomeration is 30-40° C.,
the temperature of the incoming feed air in the area of agglomeration of the material is 50-70° C.,
a 45-55% lecithin solution is added to the material in a third and fourth area, the amount of the coating material being 10-20% lecithin based on the dry material,
the material bed temperature in an area where the coating material is added is 38-45° C., and
the temperature of the incoming feed air in the area where the coating material is added is 60-90° C.

6. A process according to claim 1, characterized in that the individual areas of the fluidized bed used for heating, agglomeration, coating, drying or cooling depending on the process conditions, are designed with approximately the same size.
